(19) United States
(12) Patent Application Publication
(10) Pub. No.: US 2002/0059724 A1
(43) Pub. Date: May 23, 2002

(54) Method and attachment apparatus for attaching an electrical and/or optical cable to a cable end piece

(76) Inventor: Hans-Dieter Weigel, Caputh (DE)

Correspondence Address: LERNER AND GREENBERG, P.A., Post Office Box 2480, Hollywood, FL, 33022-2480, US

(21) Appl. No.: 10/026,498

(22) Filed: Dec. 19, 2001

Related U.S. Application Data
(63) Continuation of application No. PCT/DE00/03072, filed on Aug. 30, 2000.

(51) Int. Cl. H01R 43/00; B23P 19/00

(52) U.S. Cl. 29/857; 29/747

(57) ABSTRACT

A method and an attachment apparatus for attaching an electrical and/or optical cable to a cable end piece is described. The cable has a cable sheath to be secured in the cable end piece. Accordingly, a cable sheath end of the cable sheath is bent around an edge of a holding part, and thus is secured against being pulled out. This allows the cable to be connected to a cable end piece in a manner, which is simple, cost-effective and reliable.

### CROSS-REFERENCE TO RELATED APPLICATION

This application is a continuation of copending International Application No. PCT/DE00/03072, filed Aug. 30, 2000, which designated the United States.

### BACKGROUND OF THE INVENTION

Field of the Invention

The invention relates to a method for attaching an electrical and/or optical cable to a cable end piece and to an attachment apparatus for the electrical and/or optical cable. The invention is particularly suitable for attaching optical waveguides to optical plugs.

Numerous techniques are known for attaching cable sheaths to cable end pieces such as plugs or similar elements. The techniques have the common feature that they include either bonding of the cable sheaths, jamming, crimping (that is to say pinching) or wedging the cable sheaths to the plug. Published, European Patent Application EP 0 462 845 A1 discloses an optical plug in which the cable sheath is slit at its ends for attachment of an optical cable, the slit ends are placed over a rear-face plug connection, and are then pinched to the plug connection by a C-shaped ring. In another embodiment, an annular part is crimped over the rear-face plug connection, as a result of which the cable sheath is pressed against the plug connection. Similar cable sheath attachments are described in Published, Non-Prosecuted German Patent Application DE 38 13 976 A, U.S. Pat. No. 5,313,539 and Published, European Patent Application EP 0 131 283 A.

One disadvantage of crimping is that it is necessary to compensate for all the tolerances. In particular, the thickness tolerances of the cable sheath must be compensated for, in order to satisfy the strength requirements for the cable sheath attachment in all cases. The known methods and apparatuses, which include clamping or pinching of the cable sheath, are also relatively complex and labor-intensive. Furthermore, it is known for cable sheaths to be attached by an adhesive. However, adhesives generally have the disadvantage that the bonding reliability of the various adhesives to the different cable sheath materials does not satisfy the necessary demands in all application conditions. Particularly when subjected to temperature and moisture, adhesives and cable sheaths sometimes become detached from one another. A further disadvantage of the use of adhesives is the difficulty in handling them, as when they are being handled there is the need to take account of safety for those involved with them and the need to provide constant adhesive quality.

From the field of electrical cables, it is known for a cable to be clamped together by a transversely disposed yoke and two screws, in order in this way to prevent the cable sheath from being pulled out. The method cannot be used for optical waveguides, since optical waveguides must not be subjected to any transverse pressure.

### SUMMARY OF THE INVENTION

It is accordingly an object of the invention to provide a method and an attachment apparatus for attaching an electrical and/or optical cable to a cable end piece which overcome the above-mentioned disadvantages of the prior art methods and devices of this general type, which allow a cable to be connected to a cable end piece in a simple, cost-effective and reliable manner.

With the foregoing and other objects in view there is provided, in accordance with the invention, a method for attaching a cable having a cable sheath. The method includes the steps of providing a cable end piece for securing the cable, making at least one end part of the cable sheath available, bending back the end part around an edge of a holding part secured in the cable end piece for securing the cable to the cable end piece.

Accordingly, the solution according to the invention is characterized in that at least one end of the cable sheath is made available. The cable sheath is for this purpose slit, for example, at its end to form one or more end pieces, with the end pieces being referred to as cable sheath ends. The cable sheath ends are then each bent around or bent back around an edge of the holding part.

The process of attaching the cable sheath according to the invention is based on the fact that bending the cable sheath end around an edge results in any tensile force on the cable or on the cable sheath being absorbed by the edge. The sharper the edge in this case, and the more sharply the cable sheath end is bent around it, the greater is the resistance of the cable sheath attachment to being pulled out. The cable sheath end is thus preferably bent around a sharp edge of a holding part.

It should be mentioned that, for the purposes of the invention, the expression cable end piece refers to an apparatus, which holds the end of an electrical or optical cable. In particular, this relates to an electrical or optical plug, which is coupled to an associated female connector. Furthermore, it should be mentioned that for the purposes of the invention, the expression cable sheath refers to any outer covering on a cable.

The holding part, which is used, may be an already existing part of the cable end piece or, alternatively, a separate part, which is supported on the cable end piece or is connected in a positively locking manner to it.

The cable sheath ends are preferably bent around through essentially 180°, in order to provide a high level of resistance to being pulled out. The holding part in this case preferably runs between the bent-around cable sheath ends and the cable sheath.

It can thus act reliably at the bend point in a bent-around cable sheath end.

If the requirements for resistance to the cable being pulled out are less stringent, the cable sheath ends can also be bent around through an angle of less than 180°. However, in this case, they should be bent around through at least essentially 90°, since the resistance to being pulled out is greatly reduced at angles less than this.

The bent-around cable sheath ends are preferably fixed with respect to the cable end piece. This ensures that the cable sheath ends are not bent back, with the attachment becoming detached in the process. Separate fixing elements such as clips etc. can be used for fixing. In one preferred embodiment, the bent-around cable sheath ends are inserted into slits in individual housing parts of the cable end piece, and are hence fixed. However, depending on the material of the cable sheath, fixing may also be superfluous, specifically if the cable sheath remains pressed in the bent-around position by a compression spring, which is present anyway. It should also be mentioned that the cable sheath ends may be fixed automatically by the walls or other structures of the cable end piece.

The attachment apparatus according to the invention for an electrical and/or optical cable is distinguished in that it has an attachment for attaching the cable sheath to the cable end piece, which has at least one holding part with an edge around which a cable sheath end of the cable that is to be attached can be bent. The edge in this case absorbs tensile forces acting on the cable. Accordingly, the edge of the holding part is preferably in the form of an edge which is as sharp as possible, that is to say the edge has a small radius of curvature.

If the holding part is a component of the cable end piece, then the holding part in one preferred refinement is a thin-shaped metal sheet with a first side edge and a second side edge, with the first side edge resting against the bend point of the bent-around cable sheath end, and the second side edge being supported against a projection from the cable end piece. The projection is, in particular, the wall of a chamber, which holds the cable to be coupled.

If the holding part is a separate part, then the holding part in one preferred refinement is a sheet-metal bracket that is connected in a positively locking manner to the cable end piece. In this case, one cable sheath end is bent around an edge of the bracket.

In accordance with an added feature of the invention, the cable end piece has a housing with slits formed therein, and one of the slits holds the bent-around cable sheath end.

In accordance with an additional feature of the invention, the cable end piece has a compression spring, and the bent-around sheath end of the cable sheath is held in a bent-around position by the compression spring.

In accordance with a further feature of the invention, the cable end piece has a housing and a cover with slits formed therein, and one of the slits holds the bent-around cable sheath end.

Other features which are considered as characteristic for the invention are set forth in the appended claims.

Although the invention is illustrated and described herein as embodied in a method and an attachment apparatus for attaching an electrical and/or optical cable to a cable end piece, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a multiple plug connector for holding optical waveguides, with a cable sheath end of the optical waveguides being bent around through 180°, according to the invention;

FIG. 2 is a detailed, perspective view of the bent-around cable sheath ends of the multiple plug connector shown in FIG. 1;

FIG. 3 is a perspective view of the cable sheath end and an associated holding part of the multiple plug connector shown in FIG. 1;

FIG. 4 is a perspective view of an individual plug connector for holding an optical waveguide with the cable sheath ends which are bent around through 180°, with the optical waveguide being rotated through 90° with respect to the plug connector shown in FIG. 1 and resting flat in the plug connector;

FIG. 5 is a perspective view of the housing of a short plug connector, in which the cable sheath end of a connected optical waveguide is bent around through 90°; and

FIG. 6 is a perspective view of the plug connector shown in

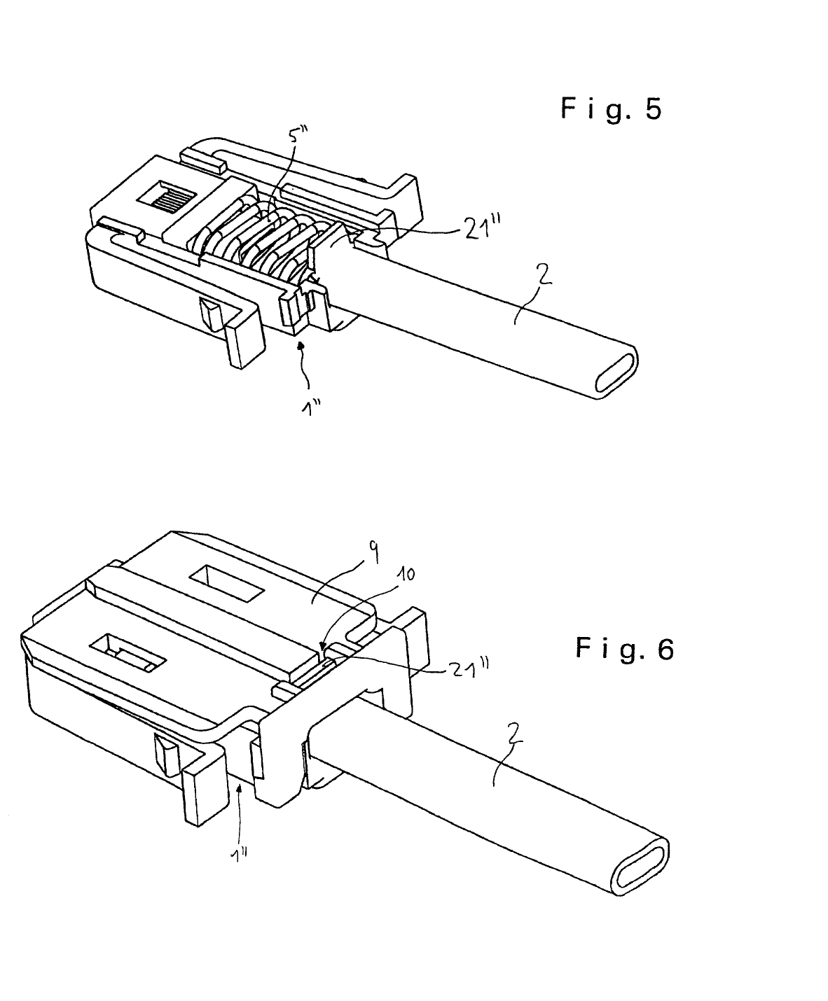

FIG. 5, with the cover fitted.

### DESCRIPTION OF THE PREFERRED EMBODIMENTS

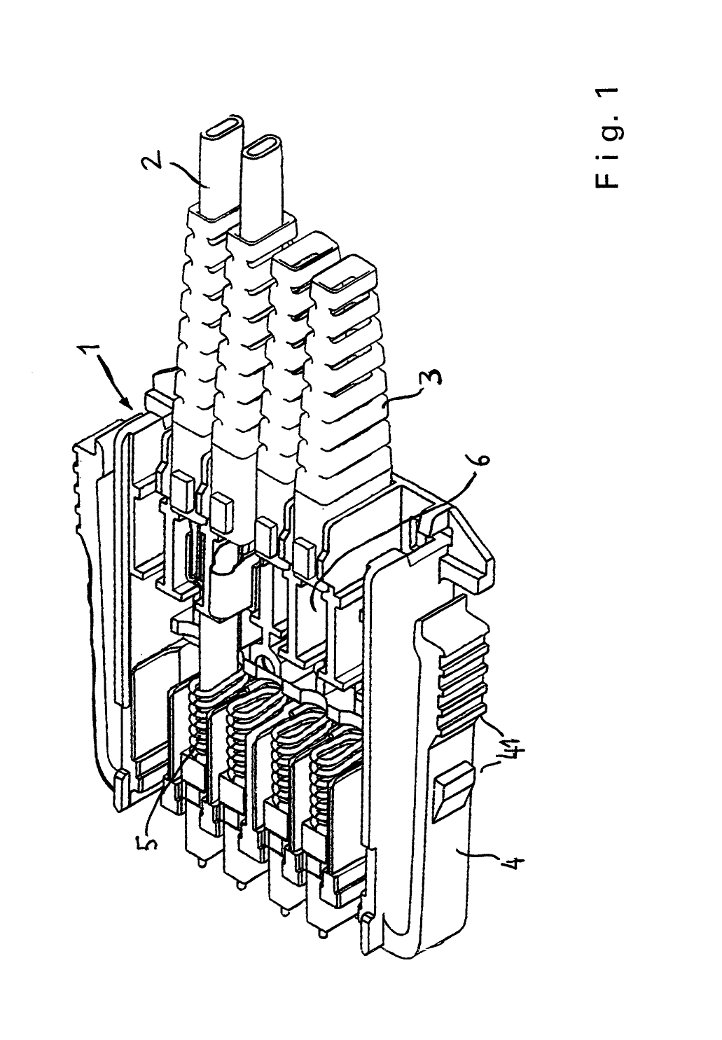

Referring now to the figures of the drawing in detail and first, particularly, to FIG. 1 thereof, there is shown a housing 1 of a cable end piece functioning as a multiple plug connector, which holds a total of up to six optical waveguide cable ends, with four connections being illustrated in FIG. 1. The optical waveguide cables each have an elastic sleeve with an outer cable sheath 2, and are connected to the housing 1 via kinking protection sleeves 3.

The multiple plug connector has a non-illustrated female connector of an optical coupling adapter, for example, associated with it, to which the optical waveguide cables are coupled via the multiple plug connector. For coupling to a female connector, the housing 1 has latching arms 4 which are formed integrally with the housing 1 in a manner known per se. The latching arms 4 have outward-oriented protrusions 41 whose stop surfaces, when they are in the locked state, rest against a stop on the female connector. The multiple plug connector is thus mechanically fixed. In the coupled state, spring elements 5 provide contact-pressure forces for the individual ferrules between the multiple plug connector and the mating coupling, with the latched-in latching arms 4 also representing an opposing bearing for the contact-pressure forces.

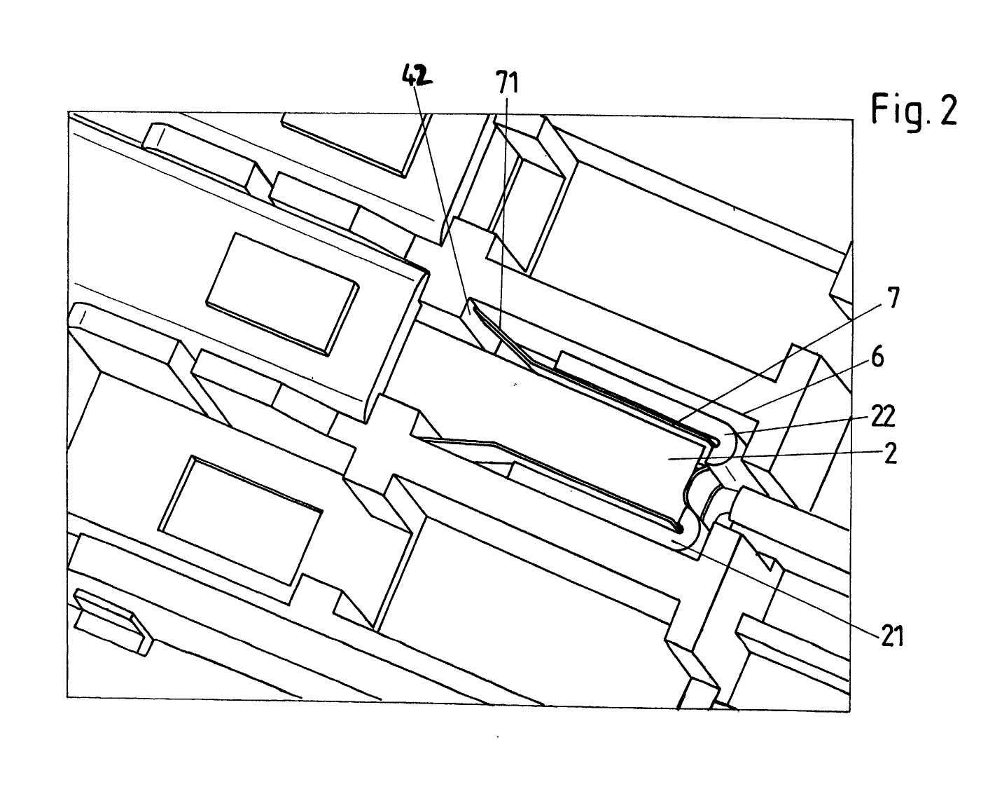

Chambers 6, which are each used to hold the cable sheath 2, are formed in the housing 1. This will be explained in the following text with reference to the detailed view in FIG. 2, in which a cable end (in contrast to the situation in FIG. 1) is supplied to the housing 1 from the left side of the illustration.

An end of the cable sheath 2 is slit to form two end pieces 21, 22. Each end piece 21, 22 is bent around to the rear through 180°, to be precise in each case about an edge of a narrow holding part 7, which is preferably produced from sheet metal and extends between the bent-around end pieces 21, 22 and the cable sheath 2. The holding part 7 is in this case supported by a lug 71, which is bent outward, against a rearward edge 42 in the chamber 6.

By bending the cable sheath end pieces 21, 22 back or around through 180° on the pointed edge of the holding part 7, any tensile forces acting on the cable end are reliably absorbed by the holding part 7. The end pieces 21, 22 are in this case reliably prevented from being bent back due to the fact that they rest against the walls of the chamber 6 of the plug housing 1.

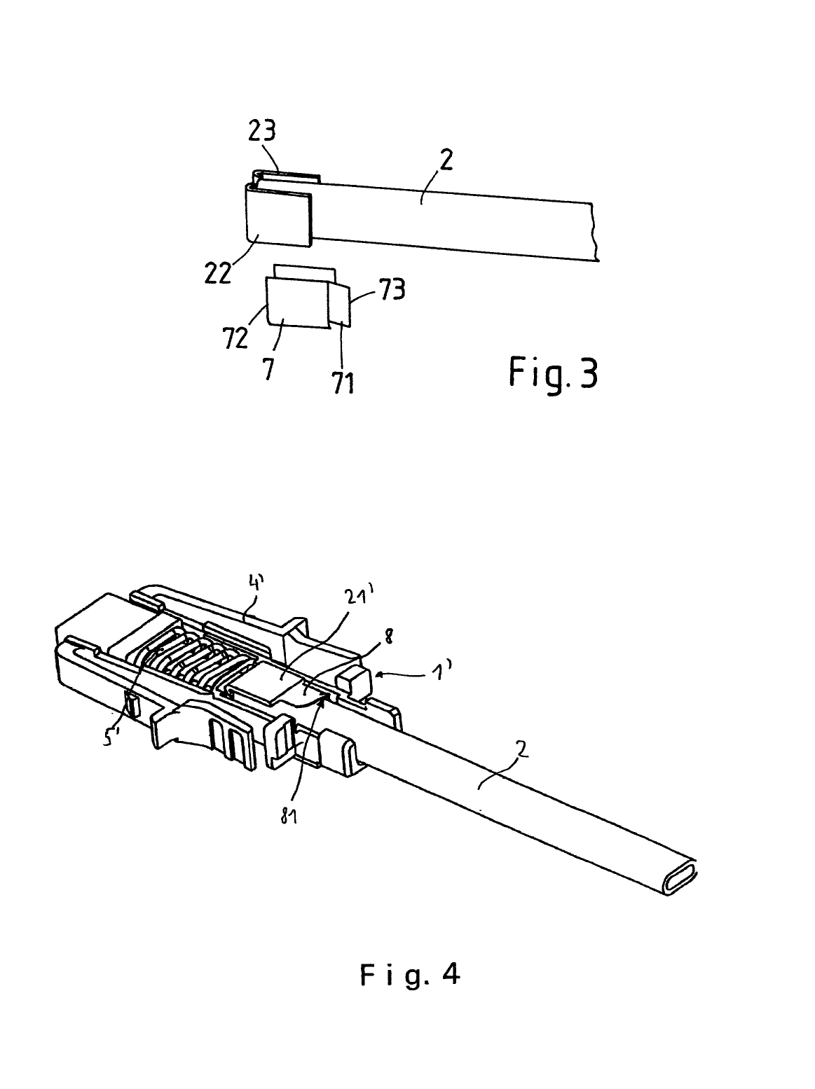

FIG. 3 shows, separately, the cable sheath end of the cable sheath 2 from FIGS. 1 and 2 with the end pieces 21, 22 bent around through 180°. The illustration likewise shows the associated holding part 7, which is composed of a thin metal sheet and has a front edge 72 and the bent lugs 71 with a rear edge 73. In this case, the front edge 72 is located such that it is supported against a bend point of the bent-around cable sheath end 21, 22, and supports the rear edge 73, as shown in FIG. 2, against the edge 42 of the chamber 6.

A ferrule, which is known per se, with the actual optical conductor is disposed, for example, within the cable sheath 2 but is not illustrated for the sake of clarity.

The attachment is produced in such a way that the cable sheath end pieces 21, 22 are produced by forming slits in an end the cable sheath 2. The end of the cable sheath 2 is then inserted into the housing 1, and the end pieces 21, 22 are bent around through 180°. Finally, the holding parts 7 are inserted. The optical cable is now secured with a high level of resistance against being pulled out of the housing 1.

In the embodiment shown in FIG. 4, the cable sheath 2 is fitted into a plug connector in a position rotated through 90° in comparison to FIG. 1, so that the cable lies flat in the plug connector. Once again, a housing 1′ with a spring 5′ and latching arms 4′ is provided, with this being a single plug connector in FIG. 4.

In order to attach the cable sheath 2, the end of the cable sheath 2 is slit to form two end pieces 21′, 22′, of which only an upper end piece 21′ can be seen in FIG. 4, and each of the end pieces 21′, 22′ is bent through 180° around the edge of a sheet-metal part 8. The sheet-metal part 8 is in each case pushed laterally between the cable sheath 2 and the bent-around end piece 21′, and is supported by a tab 81 bent out at the side against an edge of the housing 1′. When a non-illustrated cover is fitted to the housing 1′, the bent-around end piece 21′ is prevented by structures of the cover that rest against it from returning to a position where it is not bent around, thus ensuring that the cable sheath 2 is reliably attached.

FIGS. 5 and 6 show an individual plug connector 1″ without a cover (FIG. 5) and with a cover 9 (FIG. 6) fitted to it. This is a shortened plug connector, for minimum installation dimensions.

In order to attach the cable sheath 2, the cable sheath end pieces, which are once again slit but of which only the cable sheath end piece 21″ can be seen, are bent around through an angle of 9020 . A non-illustrated lower end piece is in this case bent around an edge of the housing 1″. An upper end piece 21″ is bent around an edge of the cover 9. Once the cover 9 has been attached, the cable sheath 2, and hence the optical waveguide cable, is secured with respect to axial tensile forces. A spring 5″ in this case also secures the cable sheath ends 21″, which are bent around through 90°, in their bent-around position.

Slits 10, into which the bent-around cable sheath end pieces 21″ are introduced, are formed in the housing 1″ and in the cover 9. The cable sheath end pieces 21″ are thus fixed such that they cannot bend back to the original position.

This embodiment of the invention does not require any separate sheet-metal part. An edge for supporting the bent-around cable sheath ends 21″ is made available just by structures of the plug connector housing 1″ and of the plug connector cover 9.

The implementation of the invention is not restricted to the exemplary embodiments described above. The only essential feature for the invention is that at least one cable sheath end of a cable sheath is bent around an edge of a holding part.

I claim:

1. A method for attaching a cable having a cable sheath, which comprises the steps of:
providing a cable end piece for securing the cable;
making at least one end part of the cable sheath available;
bending back the end part around an edge of a holding part secured in the cable end piece for securing the cable to the cable end piece.

2. The method according to claim 1, which comprises forming slits in an end piece of the cable sheath for making the end part available.

3. The method according to claim 1, which comprises providing the edge of the holding part to be a sharp edge and bending the end part around the sharp edge of the holding part.

4. The method according to claim 1, which comprises using a part of the cable end piece as the holding part.

5. The method according to claim 1, which comprises:
forming two end parts during the making step; and bending the end parts around through substantially 180° resulting in bent-around cable sheath ends.

6. The method according to claim 5, which comprises disposing the holding part to run between the bent-around cable sheath ends and the cable sheath.

7. The method according to claim 4, which comprises:
forming two end parts during the making step; and
bending the end parts around through substantially 90° resulting in bent-around cable sheath ends.

8. The method according to claim 5, which comprises fixing the bent-around cable sheath ends with respect to the cable end piece.

9. The method according to claim 8, which comprises inserting the bent-around cable sheath ends into slits formed in a housing of the cable end piece.

10. The method according to claim 1, which comprises using a cable selected from the group consisting of electrical cables and optical cables.

11. The method according to claim 1, which comprises supporting the holding part on a part of the cable end piece.

12. The method according to claim 1, which comprises using a plug connector as the cable end piece.

13. The method according to claim 7, which comprises fixing a cover to the cable end piece.

14. The method according to claim 13, which comprises inserting the bent-around cable sheath ends into slits formed in the cover.

15. An attachment apparatus for at least one cable being sheathed by a cable sheath, comprising:
a cable end piece for holding the cable; and
an attachment for attaching the cable sheath to said cable end piece, said attachment having at least one holding part with an edge around which an end part of the cable sheath can be bent resulting in a bent-around cable sheath end.

16. The attachment apparatus according to claim 15, wherein said edge of said holding part is a sharp edge resting against a bend point of said bent-around cable sheath end.

17. The attachment apparatus according to claim 15, wherein said holding part is a component of said cable end piece.

18. The attachment apparatus according to claim 15, wherein:
said cable end piece has a projection; and
said holding part is a thin-shaped metal sheet with a first side edge and a second side edge, said holding part disposed substantially between the cable sheath and said bent-around cable sheath end, said first side edge resting against a bend point of said bent-around cable sheath end, and said second side edge being supported against said projection.

19. The attachment apparatus according to claim 18, wherein said cable end piece has a chamber formed therein defined by walls, and said thin-shaped metal sheet is supported by said second side edge against one of said walls of said chamber, and said chamber holds the cable.

20. The attachment apparatus according to claim 15, wherein said holding part is a separate part connected to said cable end piece.

21. The attachment apparatus according to claim 18, wherein said holding part is a sheet-metal bracket connected in a positively locking manner to said cable end piece.

22. The attachment apparatus according to claim 15, wherein said cable end piece has a fixing means for fixing the bent-around cable sheath end of the cable sheath in a bent-around position.

23. The attachment apparatus according to claim 15, wherein said cable end piece has a housing with slits formed therein, and one of said slits holding the bent-around cable sheath end.

24. The attachment apparatus according to claim 15, wherein said cable end piece has a compression spring, and the bent-around sheath end of the cable sheath is held in a bent-around position by said compression spring.

25. The attachment apparatus according to claim 15, wherein said holding part is a separate part supported on said cable end piece.

26. The attachment apparatus according to claim 15, wherein said cable end piece has a housing and a cover with slits formed therein, and one of said slits holding the bent-around cable sheath end.
